(19) United States
(12) Patent Application Publication
(10) Pub. No.: US 2015/0306608 A1
(43) Pub. Date: Oct. 29, 2015

(54) Adjustable Pattern and Adjustable Flow Nozzle

(71) Applicant: Petter Investments, South Haven, MI (US)

(72) Inventors: Matthew J. Petter, South Haven, MI (US); Douglas A. Petter, South Haven, MI (US); Lucas G. Schrab, Plainwell, MI (US)

(73) Assignee: Petter Investments, South Haven, MI (US)

(21) Appl. No.: 14/261,018

(22) Filed: Apr. 24, 2014

(51) Int. Cl. B05B 1/16

(52) U.S. Cl. CPC B05B 1/16

(57) ABSTRACT

A spray nozzle includes a stem, a shaper, and a plunger. The stem has first and second portions and defines a first bore along a center axis. The second portion defines a second bore along the center axis and at least one conduit adjacent the bore. The first bore is in liquid communication with the second bore and the at least one conduit. An outer surface of the stem defines a first limit feature. The shaper collar is movably received over the stem. The shaper collar defines a second limit feature that complements the first limit feature. The contact between the limit features limits the travel of the shaper collar. The plunger has a head and a tail. The head is received in the first bore and is impassible through the second bore. The tail is received through the second bore and defines a retention feature.

### TECHNICAL FIELD

This disclosure relates to nozzles having an adjustable pattern and an adjustable flow.

### BACKGROUND

A nozzle may control the direction and characteristics of a fluid (e.g., liquid or gas) exiting a pipe or hose. Nozzles may be used in irrigation, landscape watering, fire-fighting, washing or rinsing objects, and paint spraying, among other uses. Some nozzles can control one or more of the following: the rate of a liquid flow, the speed at which the liquid flows, the direction of the liquid as it exits the nozzle, the shape that the liquid forms as it exits the nozzle (e.g., spray, mist, fan), and the pressure of the liquid as it exits the nozzle. The nozzle is usually connected to a hose or pipe that is in turn connected to a source providing the liquid.

### SUMMARY

One aspect of the disclosure provides a spray nozzle that includes a stem, a shaper collar, and a plunger. The stem has first and second portions and defines a center axis through the first and second portions. The first portion defines a first bore along the center axis, and the second portion defines a second bore along the center axis. At least one conduit is adjacent the bore. The first bore is in liquid communication with the second bore and the at least one conduit. An outer surface of the stem defines a first limit feature. The shaper collar is movably received over the stem for movement along the center axis. The shaper collar defines a second limit feature that complements the first limit feature. Contact between the first and second limit features limits travel of the shaper collar along the center axis. The plunger has a head, which is received in the first bore of the stem. The plunger also includes a tail, which is received through the second bore of the stem. The head is impassible through the second bore, and the tail defines a retention feature.

Implementations of the disclosure may include one or more of the following features. In some implementations, at least a portion of the first bore defines a frustoconical shape and the plunger head defines a shape capable of seating against the frustoconical portion of the first bore. The first portion of the stem may define a first limit feature. Additionally, the second portion of the stem defines multiple conduits that are arranged around the second bore, where each conduit is in liquid communication with the first bore.

In some implementations, the outer surface of the stem defines the first limit feature as a step revolved about the center axis. Additionally, the shaper collar may define a longitudinal axis and may be formed between first and second surfaces. The first surface is a surface of revolution about the longitudinal axis that is inward of the second surface with respect to the longitudinal axis. The first surface defines the second limit feature as a step (e.g., a square step, a V-shape step, or a U-shape step) revolved about the longitudinal axis. The stem defines a threaded portion adjacent the revolved step of the stem and the shaper collar defines a complementary threaded portion adjacent the revolved step of the shaper collar, the shaper collar threadably received on the threaded portion of the stem.

A retention clasp may be disposed on the retention feature of the tail of the plunger. Additionally or alternatively, the retention feature may be formed so as to prevent escapement of the tail from the second bore (e.g., formed as barbed end). In some examples, the tail of the plunger is threadably received by the second bore of the stem.

Another aspect of the disclosure provides a spray nozzle, which includes a center axis and a center bore therethrough along the center axis. The center bore has a first portion that defines, at least in part, a frustoconical shape. The center bore also has a second portion that defines a cylindrical shape. The stem defines one or more liquid bores off the center axis and each liquid bore is in liquid communication with the first portion of the center bore. The stem may define multiple liquid bores arranged around the second portion of the center bore. The stem defines a first limit feature. The shaper collar is movably received over the stem for movement along the center axis. The shaper collar defines a second limit feature that complements the first limit feature. Contact between the first and second limit features limits travel of the shaper collar along the center axis. A plunger is movably received in the center bore of the stem. The plunger has a head and a tail. The head is received in the first portion of the center bore, and the tail is received through the second portion of the center bore. The movement of the head alters a flow rate through the stem. In some examples, the plunger head defines a frustoconical shape capable of seating against the first portion of the center bore.

In some implementations, the tail of the plunger defines a retention feature. The retention feature may be formed so as to prevent escapement of the tail from the center bore. The tail of the plunger may be threadably received by the second portion of the center bore of the stem. Additionally or alternatively, the nozzle may include a retention clasp that is disposed on the retention feature, which may be defined as a groove.

The first limit feature joins a first outer surface of the stem and a second outer surface of the stem. In some examples, the first limit feature includes a step formed between the first and second outer surfaces of the stem. The shaper collar may have first and second inward surfaces that are joined by the second limit feature. The second limit feature may be defined as a step. The step of the stem is revolved about the center axis of the stem. Additionally or alternatively, the shaper collar may define a longitudinal axis formed between first and second surfaces. The first surface is a surface of revolution about the longitudinal axis and is positioned inward of the second surface with respect to the longitudinal axis. The first surface defines the second limit feature as a step revolved about the longitudinal axis.

In some examples, the stem defines a threaded portion adjacent to the first limit feature. In addition, the shaper collar defines a complementary threaded portion adjacent to the second limit feature. The shaper collar is threadably received on the threaded portion of the stem.

In yet another aspect of the disclosure, a spray nozzle includes a stem, a shaper, a plunger, and a retainer. The stem defines a center axis and a center bore therethrough along the center axis. The center bore has a first portion that defines, at least in part, a frustoconical shape and a second portion that defines a cylindrical shape. The stem defines liquid bores arranged around the second portion of the center bore. Each liquid bore is in liquid communication with the first portion of the center bore. The stem defines a first limit feature. The shaper collar is movably received over the stem for movement along the center axis. The shaper collar defines a second limit feature that complements the first limit feature. Contact between the first and second limit features limits travel of the shaper collar along the center axis. The plunger is movably received in the center bore of the stem. The plunger has a head and a tail. The head is received in the first portion of the center bore, and the tail is received through the second portion of the center bore. The head defines a frustoconical shape capable of seating against the first portion of the center bore and impassible through the second portion of the center bore. Movement of the head alters a flow rate through the stem. The plunger defines a retention feature. The retainer is received by the retention feature and prevents escapement of the plunger from the center bore.

In some examples, the stem has a first and a second outer surface that are joined by the first limit feature, which is defined as a step. The shaper collar has first and second inward surfaces joined by the second limit feature defined as a step. The step of the stem is revolved about the center axis of the stem. The shaper collar defines a longitudinal axis and is formed between first and second surfaces. In some examples, the first surface is a surface of revolution about the longitudinal axis. The first surface is inward of the second surface with respect to the longitudinal axis and defines the second limit feature as a step revolved about the longitudinal axis.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1A is a perspective view of an exemplary overview of an adjustable pattern and adjustable flow nozzle.

FIG. 1B is an exploded view of the exemplary adjustable pattern and adjustable flow nozzle of FIG. 1A.

FIG. 1C is a side view of the exemplary adjustable pattern and adjustable flow nozzle of FIG. 1A.

FIG. 1D is a sectional view of the exemplary adjustable pattern and adjustable flow nozzle of FIG. 1C.

FIG. 1E is a side view of the exemplary adjustable pattern and adjustable flow nozzle of FIG. 1A.

FIG. 1F is a sectional view of the exemplary adjustable pattern and adjustable flow nozzle of FIG. 1E showing liquid flowing through the nozzle.

FIG. 2A is a side view of an exemplary stem of the adjustable pattern and adjustable flow nozzle of FIG. 1A.

FIG. 2B is a front view of an exemplary stem of the adjustable pattern and adjustable flow nozzle of FIG. 1A.

FIG. 2C is a sectional view of an exemplary stem of FIG. 2A of the adjustable pattern and adjustable flow nozzle of FIG. 1A.

FIG. 3A is a front view of an exemplary shaper collar of the adjustable pattern and adjustable flow nozzle of FIG. 1A.

FIG. 3B is a front view of an exemplary shaper collar of the adjustable pattern and adjustable flow nozzle of FIG. 1A.

FIG. 3C is a sectional view of an exemplary stem of FIG. 3B of the adjustable pattern and adjustable flow nozzle of FIG. 1A.

FIG. 4A is a side view of an exemplary plunger of the adjustable pattern and adjustable flow nozzle of FIG. 1A.

FIG. 4B is a side view of an exemplary plunger of the adjustable pattern and adjustable flow nozzle having a barbed end.

Like reference symbols in the various drawings indicate like elements.

### DETAILED DESCRIPTION

A nozzle may be used to spray a liquid on various objects, such as vehicles, trucks, or airplanes. A nozzle having parts that are only detachable when the nozzle is not connected to a hose or pipe is desirable, because such a nozzle prevents inadvertent detachments of nozzle parts while in use (i.e., while spraying liquid). Such a nozzle, therefore, prevents foreign object damage to the sprayed object.

Foreign objects are a major cause of airplane damage and unscheduled maintenance. Therefore, preventing foreign object damage (FOD) is a major concern with airlines, airports, and airport tenants, because FOD can cost millions of dollars every year. As such, it is desirable to have a nozzle designed with parts that detach only upon release of the nozzle from the hose or pipe to avoid FOD to the object being sprayed.

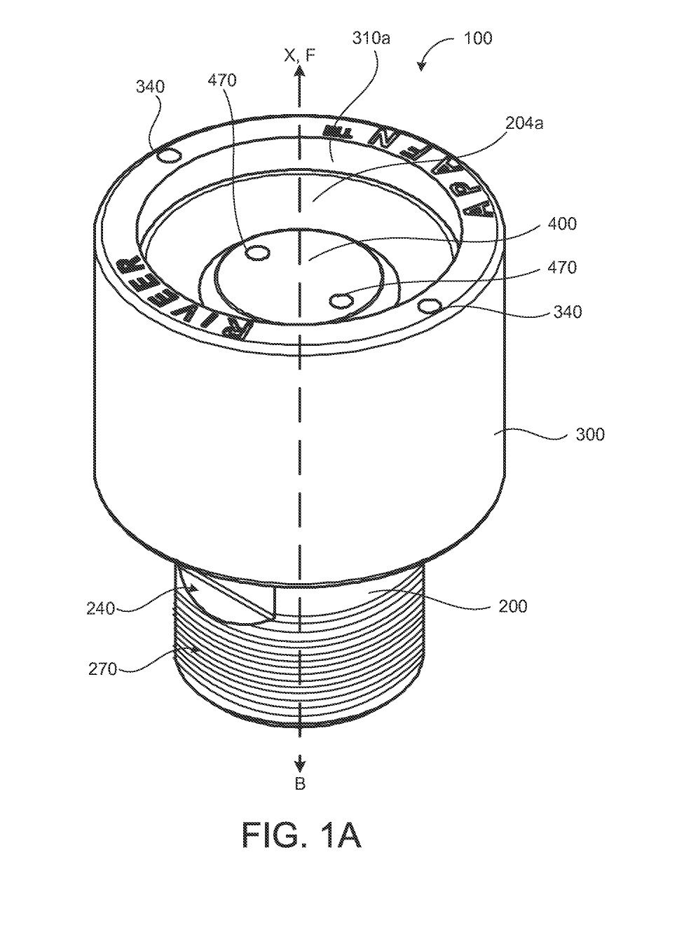

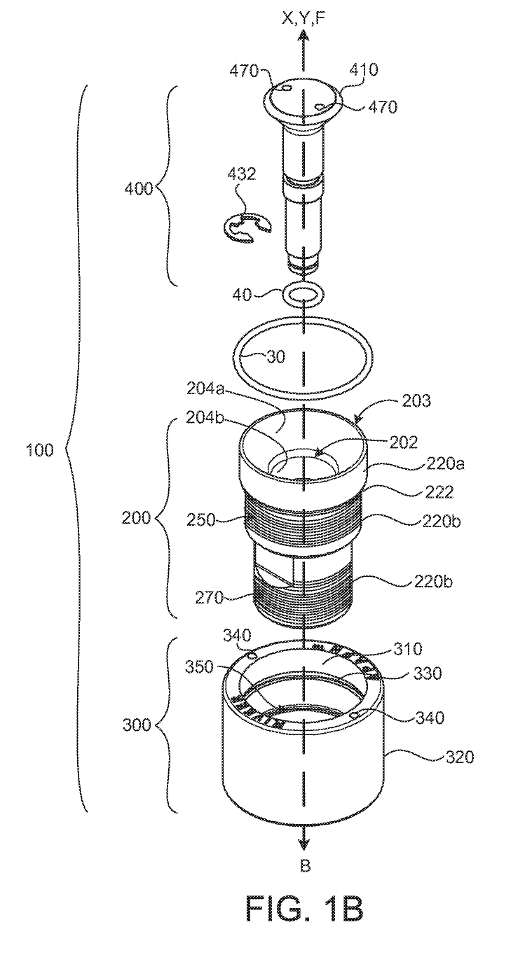

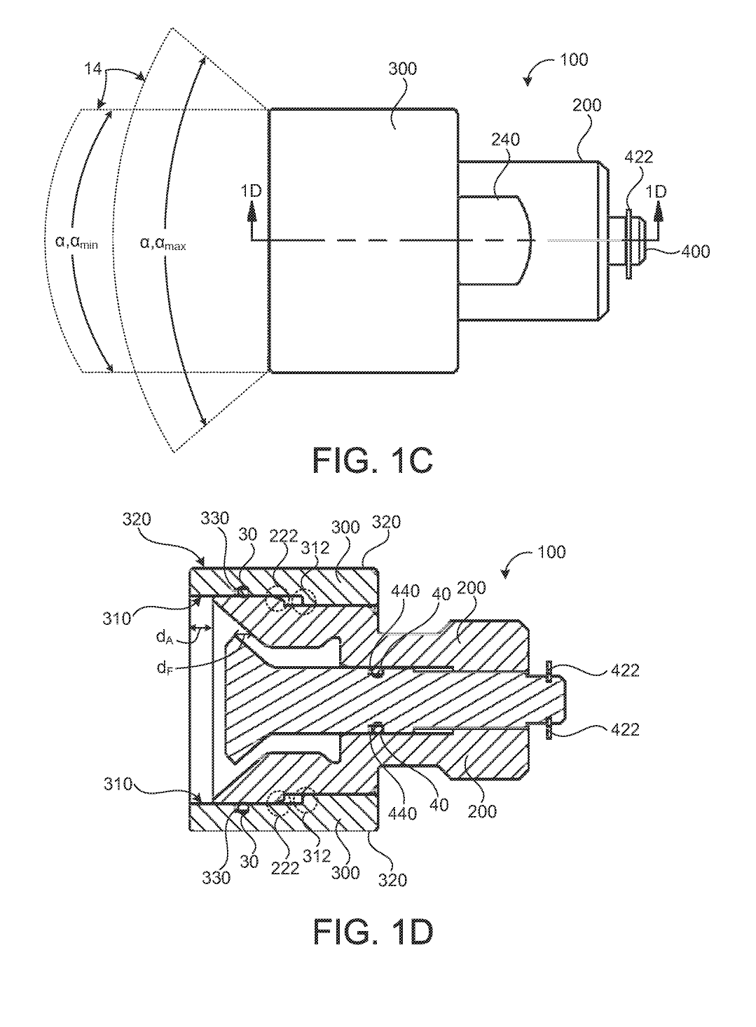

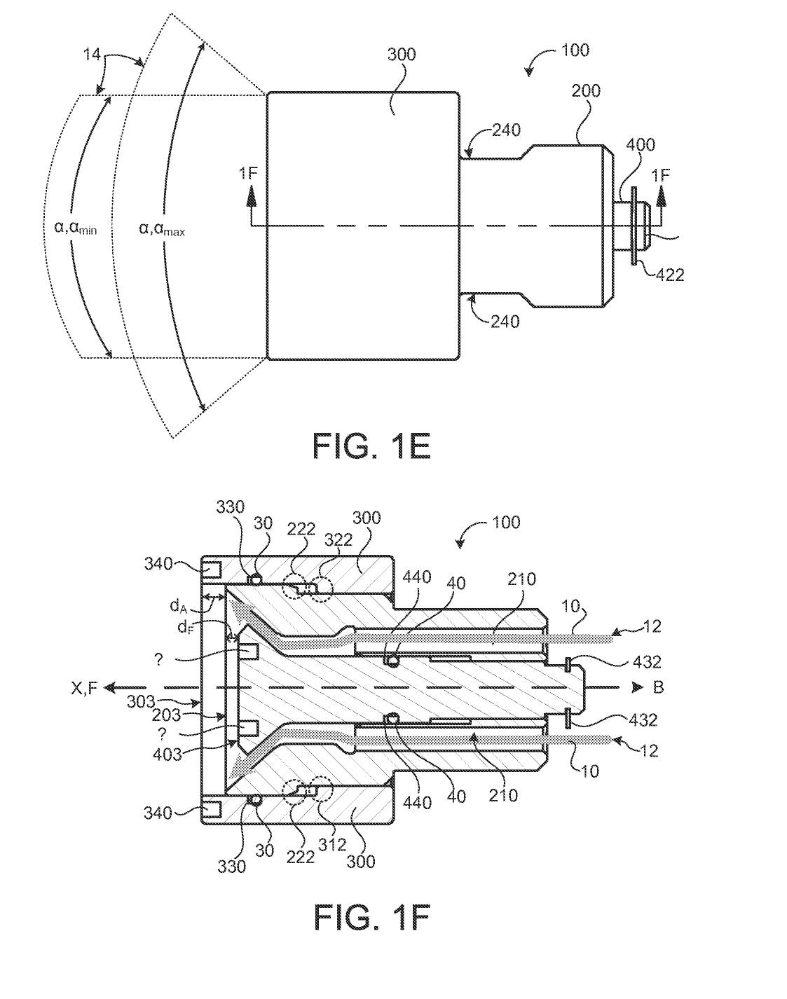

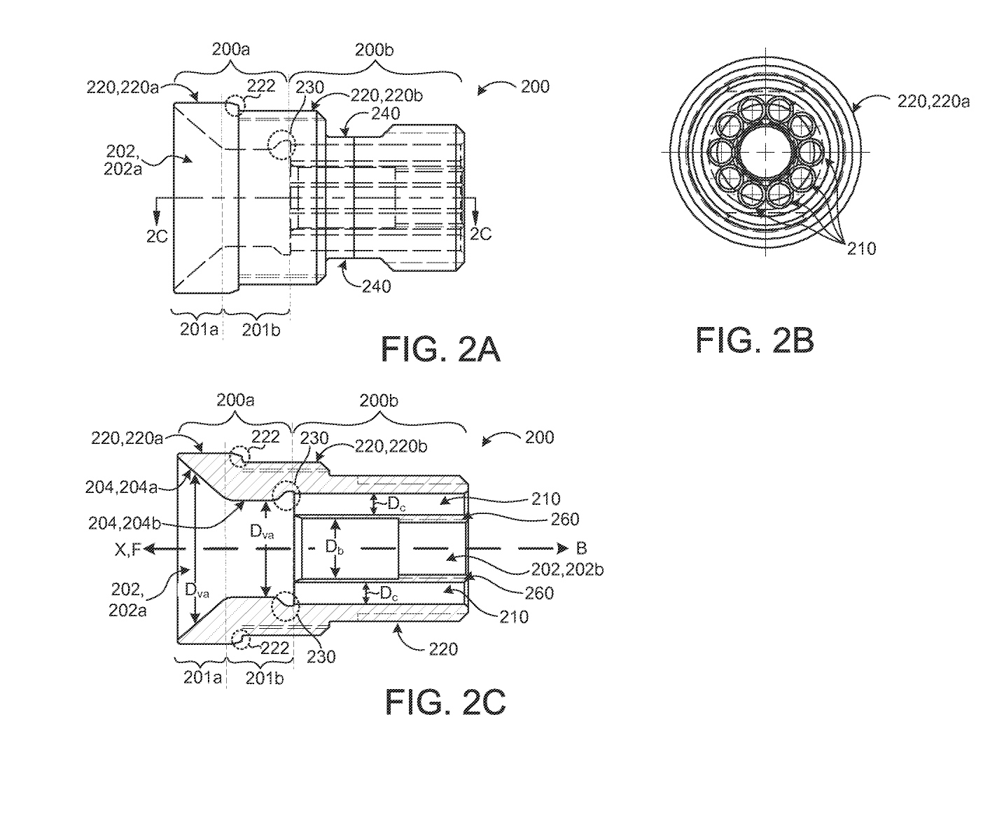

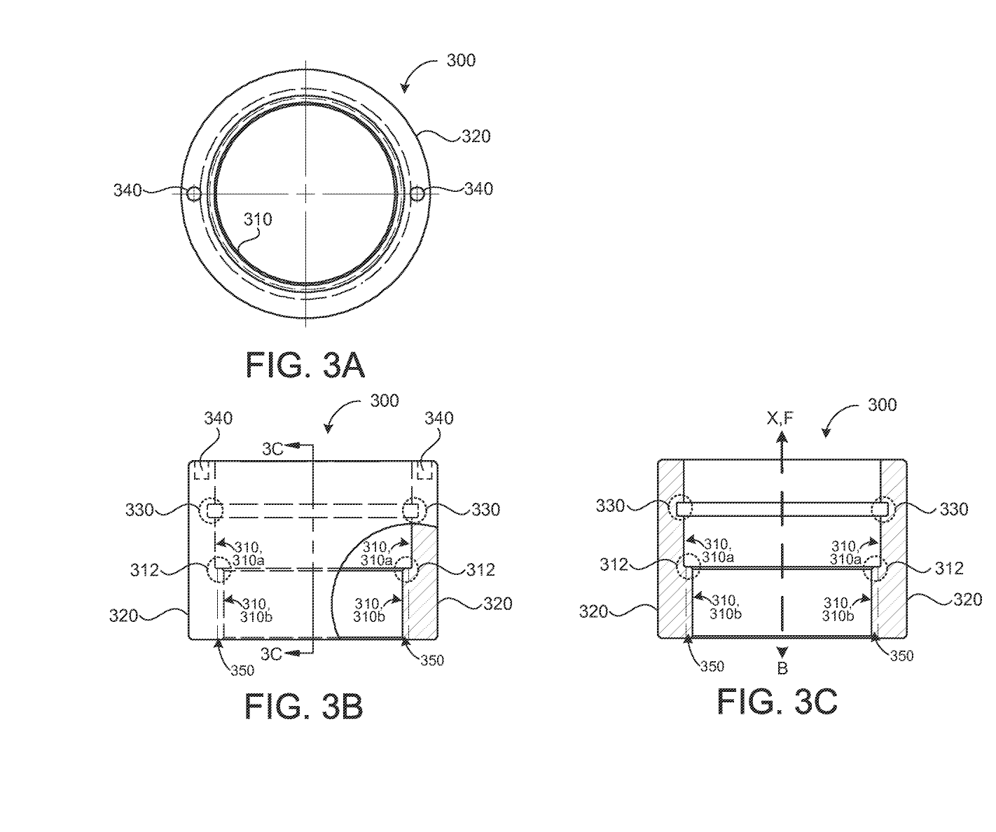

Referring to FIGS. 1A-4B, in some implementations, a spray nozzle 100 includes a stem 200, a shaper collar 300, and a plunger 400. The spray nozzle 100 is configured so that the stem 200, the shaper collar 300, and the plunger 400 are disassembled only when the spray nozzle 100 is disconnected from a hose or a pipe (not shown) that supplies the nozzle 100 with a liquid 10 (e.g., water, salt water, or chemicals). This configuration prevents any loose parts (e.g., the stem 200, the shaper collar 300, the plunger 400, or any of their respective parts) from damaging other objects. The stem 200 has a first portion 200a and a second portion 200b and defines a center axis X through the first and second portions 200a, 200b. The stem 200 defines a bore 202 along the center axis X. In some examples, the bore 202 includes a first bore 202a and a second bore 202b. The first bore 202a is in fluid communication with the second bore 202b and allows the plunger 400 to be inserted into the first and second bores 2002a, 202b. In some examples, at least one conduit 210 (discussed in more detail below) is adjacent to the second bore 202b and allows liquid 10 to flow from the conduit 210 to the first bore 202a.

The nozzle 100, including the stem 200, the shaper collar 300, and the plunger 400, may be metal or steel. Other materials are possible as well, such as plastic, composites, etc. In some examples, the nozzle 100 is made of stainless steel to prevent the nozzle 100 from corroding or rusting due to its use outdoors or due to the kind of liquid 10 flowing through the nozzle 100.

In some implementations, the first portion 200a defines the first bore 202a along the center axis X, and the second portion 200b defines the second bore 202b along the center axis X. The first bore 202a and the second bore 202b combined define the bore 202 of the stem 200. The first bore 202a may have a variable bore diameter Dᵥₐ, where the variable bore diameter Dᵥₐ on an outer side 204a of the first bore 202a closer to a terminal end (a top portion 203) of the stem 200 is greater than the variable bore diameter Dᵥₐ on an inner side 204b of the first bore 202a. In some examples, the inner side 204b of the first bore 202a includes a gathering portion 230 having a greater variable diameter Dᵥₐ than the other variable diameters Dᵥₐ of the inner side 204b of the first bore 202a. The gathering portion 230 gathers liquid received from the conduits 210 and guides the liquid 10 through a liquid path 12. In some examples, at least a portion of the first bore 202a (e.g., the outer side 204a) defines a frustoconical shape with the variable bore diameter Dᵥₐ increasing towards the top portion 203 of the stem 200. The second portion 201b of the first bore 202a may define a cylindrical shape in cross section to guide the received liquid 10 towards the first portion 201a of the first bore 202a. In some examples, the first portion 200a of the stem 200 includes an inner surface 204. The inner surface 204 includes a first surface 204a that defines the first portion 201a of the first bore 202a and a second surface 204b that defines the second portion 202b of the first bore 202a.

In some examples, the second portion 200b of the stem 200 defines one or multiple liquid bores or conduits 210 arranged around the second bore 202b. Each conduit 210 is in fluid communication with the first bore 202a. As shown, the second portion 200b of the stem 200 defines ten conduits 210 each having a cylindrical shape and a conduit diameter D_{C}. The conduit diameter D_{C} of each of the conduits 210 is equal, as shown. However, the conduit diameter D_{C} of each conduit 210 may vary. Moreover, the second portion 200b of the stem 200 may define a greater or a lesser number of conduits 210 than the number shown, each having a variable conduit diameter D_{C} or the same conduit diameter D_{C}. In addition, the conduits 210 may have other cross-sectional shapes, such as, but not limited to, a rectangular shape, a cuboid shape, or a triangular prism. The conduits 210 allow a liquid to flow from a hose or a pipe (not shown) removably attached to the stem 200 to an outer environment. At least one conduit 210 is in fluid communication with at least the first bore 202a.

In some implementations, the stem 200 includes an outer surface 220 that defines a first limit feature 222. In some examples, the outer surface 220 of the stem 200 includes a first outer surface 220a and a second outer surface 220b. The first limit feature 222 joins the first outer surface 220a and the second outer surface 220b. The limit feature 222 may be along the first portion 200a of the stem 200 (as shown) or along the second portion 200b of the stem 200. In some examples, the outer surface 220 of the stem 200 defines the first limit feature 222 as a step revolved about the center axis X. In other examples, the first limit feature 222 includes a step formed between the first outer surface 220a and the second outer surface 220b. The first limit 222 may have different step shapes. The first limit feature 222 may have several shapes including, but not limited to, a square step, a V-shape step, or a U-shape step, where the profile of the shape is revolved around the center axis Y.

In some examples, the stem 200 includes an indentation 240 on the second portion 200b of the stem 200. The indentation 240 allows a user to better grip the stem 200 using his/her fingers or a tool for connecting, disconnecting, or adjusting the stem 200 from the shaper collar 300, the plunger 400, or a hose or pipe.

The shaper collar 300 is movably received over the stem 200 for movement along the center axis X. The shaper collar 300 defines a second limit feature 312 that is complementary to the first limit feature 222. In some examples, the shaper collar 300 defines a longitudinal axis Y, substantially parallel to the center axis X. The longitudinal axis Y is formed between a first surface 310 (e.g., an inner shaper collar surface) and a second surface 320 (e.g., an outer shaper collar surface). The second surface 320 may have a cylindrical shape, a square shape, a pentagon shape, or any other shape. The first surface 310 is a surface of revolution about the longitudinal axis Y. The first surface 310 is inward of the second surface 320 with respect to the longitudinal axis Y and defines the second limit feature 312. The second limit feature 312 may be a step revolved about the longitudinal axis Y. The surface of revolution is a surface formed by rotating a curve around a straight line in its plane. The second limit feature 312 may have several shapes including, but not limited to, a square step, a V-shape step, or a U-shape step, where the profile of the shape is revolved around the longitudinal axis Y and the shape of the second limit feature 312 complements the shape of the first limit feature 222. Therefore, contact between the first limit feature 222 and second limit feature 312 limits travel of the shaper collar 300 along the center axis X and the longitudinal axis Y. The first and second limit features 222, 312 allow the shaper collar 300 to connect to the stem 200 by engaging the shaper collar 300 towards the stem 200 in a forward direction F and releasing the shaper collar 300 from the stem 200 in a backward direction B only. Therefore, the shaper collar 300 can only be released by motion along the backward direction B, which is opposite the motion of the liquid 10 flowing through the nozzle in the forward direction F.

In some examples, the inward surface 310 includes a first inward surface 310a and a second inward surface 310b. The first inward surface 310a may be joined to the second inward surface 310b by the second limit feature 312. The second limit feature 312 defines a step complementary to a step defined by the first limit feature 222.

In some implementations, the stem 200 defines a first threaded portion 250 adjacent to the first limit feature 222 and the shaper collar 300 defines a complementary threaded portion 350 adjacent the second limit feature 312. The shaper collar 300 is threadably received on the threaded portion of the stem 200. The shaper collar 300 may be threadably received on the first threaded portion 250 of the stem 200 in the forward direction F and only released in a backward direction B (being opposite the direction of the forward direction F).

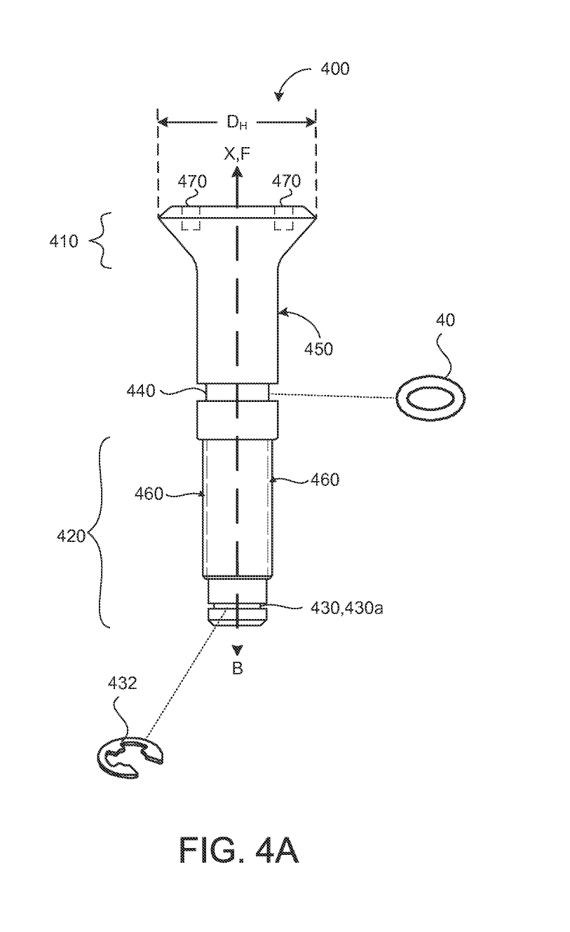

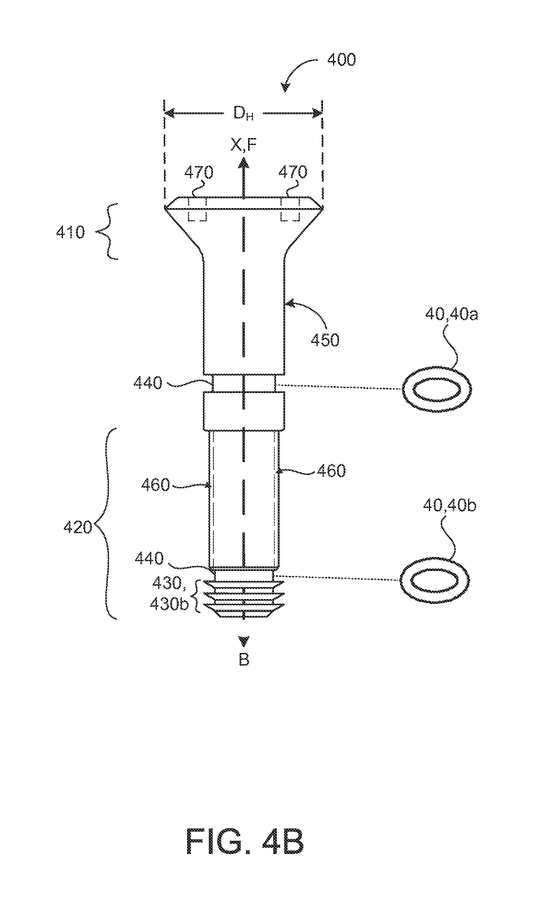

Referring to FIGS. 4A and 4B, in some implementations, the plunger 400 is movably received in the center bore 202 of the stem 200. The plunger 400 includes a head 410, which is received in the first bore 202a of the stem 200. The plunger 400 also includes a tail 420, which is received through the second bore 202b of the stem 200. In some examples, the tail 420 defines a threaded portion 460 and the stem 200 defines a second threaded portion 260 complementary to the threaded portion 460 of the plunger 400. The second portion 200b of the stem 200 defines the second threaded portion 260. The plunger 400 is threadably received on the second inner threaded portion 260 of the stem 200. Therefore, the tail 420 is threadably received by the second bore 202b of the stem 200. The head 410 is impassible through the second bore 202b, because the head 410 has a greater diameter D_{II} than the bore diameter Dᵥₐ of the inner side 204b of the first bore 202a. The plunger head 410 defines a shape capable of seating against a frustoconical portion of the first bore 202a (as previously described). The shape of the plunger head 410 is complementary to the shape of the outer side 204a of the bore closer to the environment (which has a greater variable diameter Dᵥₐ than the variable bore diameter Dᵥₐ on an inner side 204b of the bore 202a.)

The movement of the plunger head 410 alters a flow rate of liquid 10 through the stem 200. When a user tightens the plunger 400 with the stem 200 (e.g., threads the plunger into the stem 22), the plunger head 410 creates a narrower liquid path 12 between it and the outer side 204a of the first bore 202a of the stem 200.

The tail 420 defines a retention feature 430 that prevents the tail 420 from being released from the stem 200 (i.e., the bore 202 of the stem 200) when liquid 10 is flowing in its liquid path 12. Referring to FIG. 4A, the retention feature 430 may be an indentation 430a within the tail 420 for receiving a retention clasp or retainer 432. The retention clasp 432 may be disposed on or received by the retention feature 430. The retention clasp 432 prevents the escapement of the plunger 400 from the center bore 202 of the stem 200. In some examples, the retention clasp 432 is an E-clasp 432 as shown in the FIGS. A user may connect the retention clasp 432 to the retention feature 430 after the user inserts the plunger 400 in the bore 202 of the stem 200. The retention clasp 432 is configured to prevent the plunger 400 from releasing from the bore 202 of the stem 200 and causing any damage to other objects. Thus, to disassemble the plunger 400 from the stem 200, the user first disengages the retention clasp 432 from the retention feature 430 of the plunger 400 and then releases the plunger 400 from the stem 200 (e.g., unthreads the plunger 400 from the stem 200).

Referring to FIG. 4B, in some examples, the retention feature 430 defines a barbed end 430b disposed on the tail 420 of the plunger 400. When a user inserts the plunger 400 in the stem 200, the barbed end 430b prevents the plunger 400 from being released from the stem 200. Therefore, when the plunger 400 is inserted into the bore 202 of the stem 200, the user cannot release the plunger 400 from the stem 200.

In some examples, a first O-ring 40, 40a is disposed between the stem 200 and the shaper collar 300 in a collar depression 330 revolved about the longitudinal axis Y (or the center axis X). The collar depression 330 is defined by the inward surface 310 of the shaper collar 300. A second O-ring 40, 40b may be disposed between the stem 200 and the plunger 400 in a plunger depression 440 revolved about the longitudinal axis Y (or the center axis X). The O-ring(s) 40 may provide a frictional fit between mating surfaces, such that nozzle setting do not change unintentionally (e.g., via vibration). The plunger depression 440 is defined by an outer surface 450 of the plunger 400 between the head 410 and the retention feature 430.

The second portion 200b of the stem 200 defines a third threaded portion 270. Once the nozzle 100 is assembled, a hose or nozzle is threadably attached to the third threaded portion 270. Once attached to the pipe or hose, the user may adjust the water flow, the water pressure, and the flow angle.

Referring back to FIGS. 1E and 1F, an angular distance d_{A} is a distance between the top portion 303 of the shaper collar 300 and the top portion 203 of the stem 200. The angular distance d_{A} determines a flow angle α of the liquid 10 from the nozzle 100. When the angular distance d_{A} is at its maximum distance, the liquid 10 flows at a minimum flow angle αₘᵢₙ because the shaper collar 300 guides the liquid 10 in a straight forward direction F. In some examples, minimum flow angle αₘᵢₙ equals to zero and guides the liquid 10 in a straight flow as it exits the nozzle 100. When the angular distance d_{A} is at its minimum distance and the top portion 203 of the stem 200 is substantially aligned with the top portion 303 of the shaper collar 300, the liquid 10 flows at a maximum flow angle αₘₐₓ because the shaper collar 300 fails to guide the liquid 10 and the liquid 10 flows in a direction defined by the shape of the portion of the first bore 202a (e.g., the outer side 204a). In some examples, the maximum flow angle αₘₐₓ is less than or equal to 90 degrees (e.g., 82 degrees).

A flow distance d_{F} is a distance between the first surface 204a of the inner surface 204 of the stem 200 and the plunger 400. At a minimum flow distance d_{F} the head 410 of the plunger 400 is in contact with the first surface 204a of the inner surface 204 of the stem 200 and prevents any liquid 10 from flowing through the liquid path 12. At a minimum flow distance d_{F} the plunger 400 is furthest from the first surface 204a of the inner surface 204 of the stem 200 and allows for the greatest liquid path 12. A user may adjust the flow distance d_{F} to provide a liquid path 12 of liquid 10 between 1 and 35 gallons per minute and a pressure of between 10 psi and 1200 psi.

A user may adjust one or both of the angular distance d_{A} and flow distance d_{F}. A user may adjust the flow distance d_{F} by rotating the plunger 400 about the center axis X (e.g., screwing the plunger with respect to the threadably received stem 200). As the user rotates the plunger 400 towards the forward direction F, the flow distance dr increases allowing an increase or widening of the liquid path 12. Moreover, if the user rotates the plunger 400 in a backward direction B about the center axis X, the flow distance d_{F} decreases allowing a decrease in liquid path 12.

Additionally or alternatively, a user may adjust the angular distance d_{A} by rotating the shaper collar 300 about the center axis X towards the forward direction F or the backward direction B. In some examples, the shaper collar 300 is threadably received over the stem 200, and rotation of the shaper collar 300 with respect to the stem 200 causes the shaper collar 300 to move axially along the center axis X with respect to the stem 200. Movement of the shaper collar 300 towards the forward direction F increases the angular distance d_{A} allowing a narrower flow angle α, and movement of the shaper collar 300 towards the backward direction B decreases the angular distance d_{A} allowing a wider flow angle α.

A user may manually rotate the shaper collar 300 or the plunger 400 with respect to the threadably received stem 200. In some examples, the user needs tools to rotate either the shaper collar 300 or the plunger 400. In some examples, the shaper collar 300 includes two receptacles 340 for receiving a tool (not shown) having a complementary shape to adjust the shaper collar 300, thus adjusting the flow angle α. Additionally or alternatively, the plunger 400 may include two plunger receptacles 470 for receiving a tool having complementary shapes to adjust the plunger 400 and control the flow rate. Therefore, a unique tool might be needed to make any adjustments to the nozzle 100, providing a tamper-proof setting, which is only adjustable by trained users having the right tools. In other examples, the nozzle is adjustable with tool-less features.

A number of implementations have been described. Nevertheless, it will be understood that various modifications may be made without departing from the spirit and scope of the disclosure. Accordingly, other implementations are within the scope of the following claims.

What is claimed is:

1. A spray nozzle comprising:
a stem having first and second portions and defining a center axis through the first and second portions, the first portion defining a first bore along the center axis, the second portion defining a second bore along the center axis and at least one conduit adjacent the bore, the first bore in liquid communication with the second bore and the at least one conduit, an outer surface of the stem defining a first limit feature;
a shaper collar movably received over the stem for movement along the center axis, the shaper collar defining a second limit feature complementary to the first limit feature, contact between the first and second limit features limiting travel of the shaper collar along the center axis; and
a plunger having a head received in the first bore of the stem and a tail received through the second bore of the stem, the head being impassible through the second bore, the tail defining a retention feature.

2. The spray nozzle of claim 1, wherein at least a portion of the first bore defines a frustoconical shape and the plunger head defines a shape capable of seating against the frustoconical portion of the first bore.

3. The spray nozzle of claim 1, wherein the second portion of the stem defines multiple conduits arranged around the second bore, each conduit in liquid communication with the first bore.

4. The spray nozzle of claim 1, wherein the first portion of the stem defines the first limit feature.

5. The spray nozzle of claim 1, wherein the outer surface of the stem defines the first limit feature as a step revolved about the center axis.

6. The spray nozzle of claim 5, wherein the shaper collar defines a longitudinal axis and is formed between first and second surfaces, the first surface being a surface of revolution about the longitudinal axis, the first surface inward of the second surface with respect to the longitudinal axis and defining the second limit feature as a step revolved about the longitudinal axis.

7. The spray nozzle of claim 6, wherein the stem defines a threaded portion adjacent the revolved step of the stem and the shaper collar defines a complementary threaded portion adjacent the revolved step of the shaper collar, the shaper collar threadably received on the threaded portion of the stem.

8. The spray nozzle of claim 1, further comprising a retention clasp disposed on the retention feature.

9. The spray nozzle of claim 1, wherein the retention feature prevents escapement of the tail from the second bore.

10. The spray nozzle of claim 1, wherein the tail of the plunger is threadably received by the second bore of the stem.

11. A spray nozzle comprising:
a stem defining a center axis and a center bore therethrough along the center axis, the center bore having a first portion defining, at least in part, a frustoconical shape and a second portion defining a cylindrical shape, the stem defining one or more liquid bores off the center axis, each liquid bore in liquid communication with the first portion of the center bore, the stem defining a first limit feature;
a shaper collar movably received over the stem for movement along the center axis, the shaper collar defining a second limit feature complementary to the first limit feature, contact between the first and second limit features limiting travel of the shaper collar along the center axis; and
a plunger movably received in the center bore of the stem, the plunger having a head received in the first portion of the center bore and a tail received through the second portion of the center bore, movement of the head altering a flow rate through the stem.

12. The spray nozzle of claim 11, wherein the stem defines multiple liquid bores arranged around the second portion of the center bore.

13. The spray nozzle of claim 1, wherein the tail of the plunger defines a retention feature.

14. The spray nozzle of claim 13, wherein the retention feature prevents escapement of the tail from the center bore.

15. The spray nozzle of claim 13, wherein the tail of the plunger is threadably received by the second portion of the center bore of the stem.

16. The spray nozzle of claim 13, further comprising a retention clasp disposed on the retention feature.

17. The spray nozzle of claim 11, wherein the plunger head defines a frustoconical shape capable of seating against the first portion of the center bore.

18. The spray nozzle of claim 11, wherein the stem has first and second outer surfaces joined by the first limit feature.

19. The spray nozzle of claim 18, wherein the first limit feature comprises a step formed between the first and second outer surfaces of the stem.

20. The spray nozzle of claim 19, wherein the shaper collar has first and second inward surfaces joined by the second limit feature, the second limit feature defined as a step.

21. The spray nozzle of claim 20, wherein the step of the stem is revolved about the center axis of the stem.

22. The spray nozzle of claim 21, wherein the shaper collar defines a longitudinal axis and is formed between first and second surfaces, the first surface being a surface of revolution about the longitudinal axis, the first surface inward of the second surface with respect to the longitudinal axis and defining the second limit feature as a step revolved about the longitudinal axis.

23. The spray nozzle of claim 11, wherein the stem defines a threaded portion adjacent the first limit feature and the shaper collar defines a complimentary threaded portion adjacent the second limit feature, the shaper collar threadably received on the threaded portion of the stem.

24. A spray nozzle comprising:
a stem defining a center axis and a center bore therethrough along the center axis, the center bore having a first portion defining, at least in part, a frustoconical shape and a second portion defining a cylindrical shape, the stem defining liquid bores arranged around the second portion of the center bore, each liquid bore in liquid communication with the first portion of the center bore, the stem defining a first limit feature;
a shaper collar movably received over the stem for movement along the center axis, the shaper collar defining a second limit feature complementary to the first limit feature, contact between the first and second limit features limiting travel of the shaper collar along the center axis; and
a plunger movably received in the center bore of the stem, the plunger having a head received in the first portion of the center bore and a tail received through the second portion of the center bore, the head defining a frustoconical shape capable of seating against the first portion of the center bore and impassible through the second portion of the center bore, movement of the head altering a flow rate through the stem, the plunger defining a retention feature; and
a retainer received by the retention feature, the retainer preventing escapement of the plunger from the center bore.

25. The spray nozzle of claim 24, wherein the stem has first and second outer surfaces joined by the first limit feature defined as a step; and
wherein the shaper collar has first and second inward surfaces joined by the second limit feature defined as a step.

26. The spray nozzle of claim 25, wherein the step of the stem is revolved about the center axis of the stem; and
wherein the shaper collar defines a longitudinal axis and is formed between first and second surfaces, the first surface being a surface of revolution about the longitudinal axis, the first surface inward of the second surface with respect to the longitudinal axis and defining the second limit feature as a step revolved about the longitudinal axis.
